(19) United States
(12) Patent Application Publication
(10) Pub. No.: US 2024/0089929 A1
(43) Pub. Date: Mar. 14, 2024

(54) BEAM SWITCHING GAP BASED ON USER EQUIPMENT CAPABILITY

(71) Applicant: QUALCOMM INCORPORATED, San Diego, CA (US)

(72) Inventors: Yan ZHOU, San Diego, CA (US); Fang YUAN, Beijing (CN); Wooseok NAM, San Diego, CA (US); Tao LUO, San Diego, CA (US)

(21) Appl. No.: 18/263,663

(22) PCT Filed: Mar. 31, 2021
(86) PCT No.: PCT/CN2021/084453

§ 371 Date: Jul. 31, 2023

(51) Int. Cl. H04W 72/044; H04W 72/231; H04W 72/232

(52) U.S. Cl. CPC H04W 72/044; H04W 72/231; H04W 72/232

(57) ABSTRACT

Various aspects of the present disclosure generally relate to wireless communication. In some aspects, a user equipment (UE) may transmit, to abase station, a UE capability report including an indication of a minimum time interval between starting symbols of communications associated with different beam indications. The UE may receive, from the base station, a first beam indication associated with a first communication, wherein the first communication is scheduled such that a starting symbol of the first communication is not within the minimum time interval of a starting symbol of a second communication associated with a second beam indication that is different from the first beam indication. Numerous other aspects are described.

### FIELD OF THE DISCLOSURE

Aspects of the present disclosure generally relate to wireless communication and to techniques and apparatuses for a beam switching gap based on user equipment (UE) capability.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory; and one or more processors, coupled to the memory, configured to: transmit, to a base station, a UE capability report including an indication of a minimum time interval between starting symbols of communications associated with different beam indications; and receive, from the base station, a first beam indication associated with a first communication, wherein the first communication is scheduled such that a starting symbol of the first communication is not within the minimum time interval of a starting symbol of a second communication associated with a second beam indication that is different from the first beam indication.

In some aspects, a base station for wireless communication includes a memory; and one or more processors, coupled to the memory, configured to: receive, from a UE, a UE capability report including an indication of a minimum time interval between starting symbols of communications associated with different beam indications; and transmit, to the UE, a first beam indication associated with a first communication, wherein the first communication is scheduled such that a starting symbol of the first communication is not within the minimum time interval of a starting symbol of a second communication associated with a second beam indication that is different from the first beam indication.

In some aspects, a method of wireless communication performed by a UE includes transmitting, to a base station, a UE capability report including an indication of a minimum time interval between starting symbols of communications associated with different beam indications; and receiving, from the base station, a first beam indication associated with a first communication, wherein the first communication is scheduled such that a starting symbol of the first communication is not within the minimum time interval of a starting symbol of a second communication associated with a second beam indication that is different from the first beam indication.

In some aspects, a method of wireless communication performed by a base station includes receiving, from a UE, a UE capability report including an indication of a minimum time interval between starting symbols of communications associated with different beam indications; and transmitting, to the UE, a first beam indication associated with a first communication, wherein the first communication is scheduled such that a starting symbol of the first communication is not within the minimum time interval of a starting symbol of a second communication associated with a second beam indication that is different from the first beam indication.

In some aspects, a non-transitory computer-readable medium storing a set of instructions for wireless communication includes one or more instructions that, when executed by one or more processors of a UE, cause the UE to: transmit, to a base station, a UE capability report including an indication of a minimum time interval between starting symbols of communications associated with different beam indications; and receive, from the base station, a first beam indication associated with a first communication, wherein the first communication is scheduled such that a starting symbol of the first communication is not within the minimum time interval of a starting symbol of a second communication associated with a second beam indication that is different from the first beam indication.

In some aspects, a non-transitory computer-readable medium storing a set of instructions for wireless communication includes one or more instructions that, when executed by one or more processors of a base station, cause the base station to: receive, from a UE, a UE capability report including an indication of a minimum time interval between starting symbols of communications associated with different beam indications; and transmit, to the UE, a first beam indication associated with a first communication, wherein the first communication is scheduled such that a starting symbol of the first communication is not within the minimum time interval of a starting symbol of a second communication associated with a second beam indication that is different from the first beam indication.

In some aspects, an apparatus for wireless communication includes means for transmitting, to a base station, a capability report including an indication of a minimum time interval between starting symbols of communications associated with different beam indications; and means for receiving, from the base station, a first beam indication associated with a first communication, wherein the first communication is scheduled such that a starting symbol of the first communication is not within the minimum time interval of a starting symbol of a second communication associated with a second beam indication that is different from the first beam indication.

In some aspects, an apparatus for wireless communication includes means for receiving, from a UE, a UE capability report including an indication of a minimum time interval between starting symbols of communications associated with different beam indications; and means for transmitting, to the UE, a first beam indication associated with a first communication, wherein the first communication is scheduled such that a starting symbol of the first communication is not within the minimum time interval of a starting symbol of a second communication associated with a second beam indication that is different from the first beam indication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of using beams for communications between a base station and a UE, in accordance with the present disclosure

FIGS. 4-6 are diagrams illustrating examples associated with a beam switching gap based on UE capability, in accordance with the present disclosure.

FIGS. 7-8 are diagrams illustrating example processes associated with a beam switching gap based on UE capability, in accordance with the present disclosure.

FIGS. 9-10 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

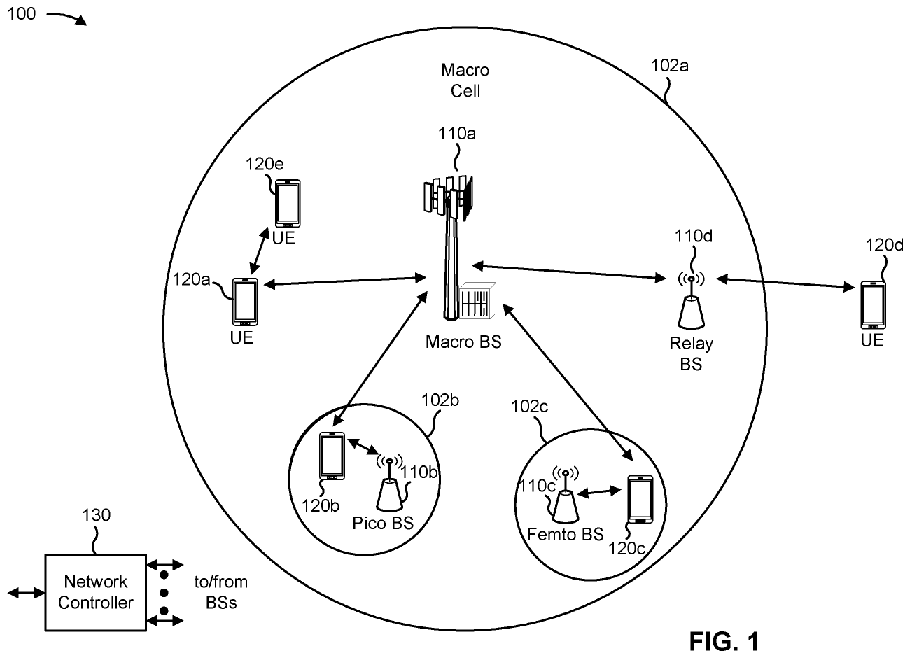

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. The mid-band frequencies may include a third frequency range (FR3), which may span from 10 GHz to 20 GHz. In some examples, devices of the wireless network 100 may communicate using an operating band having a fourth frequency range (FR4), which may span from 52.6 GHz to 114.25 GHz. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, frequencies within FR4, and/or mid-band frequencies (e.g., less than 24.25 GHz). It is contemplated that the frequencies included in FR1, FR2, FR3, and FR4 may be modified, and techniques described herein are applicable to those modified frequency ranges.

As indicated above, FIG. 1 is provided as an example. Other examples may differ from what is described with regard to FIG. 1.

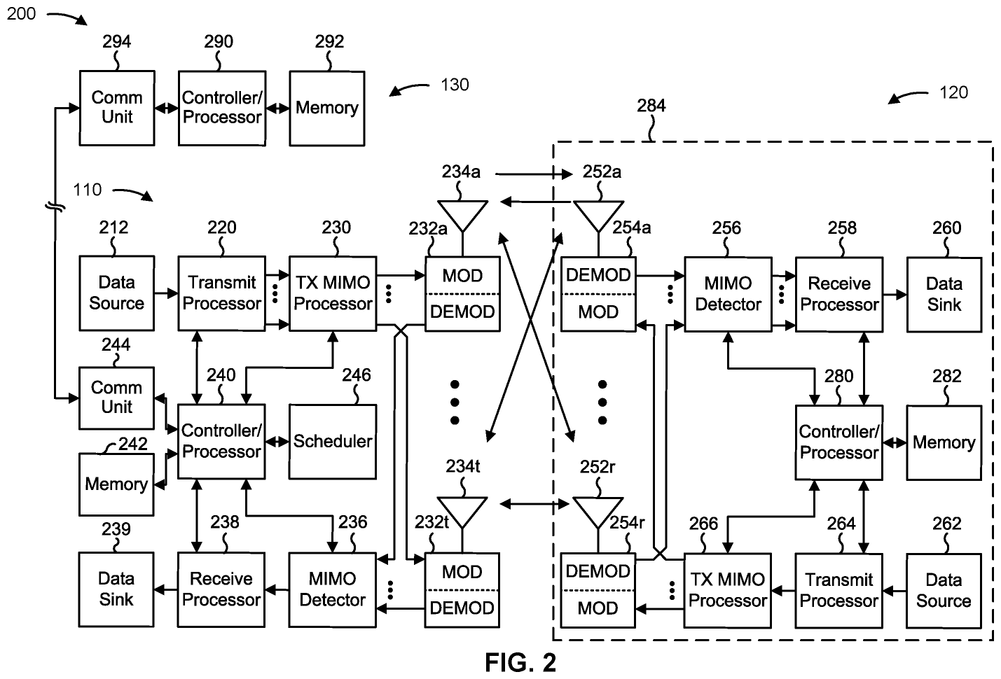

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

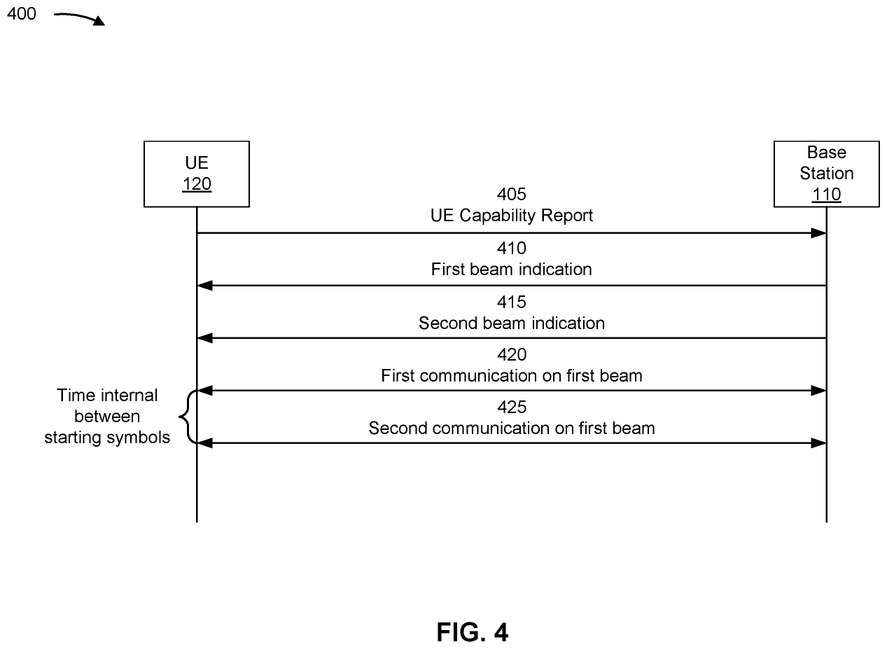

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-8).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-8).

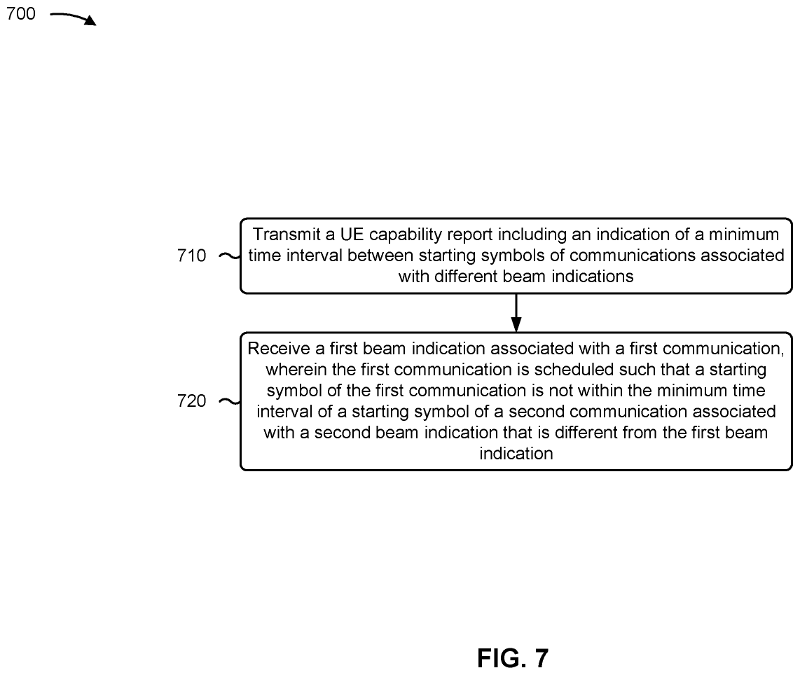

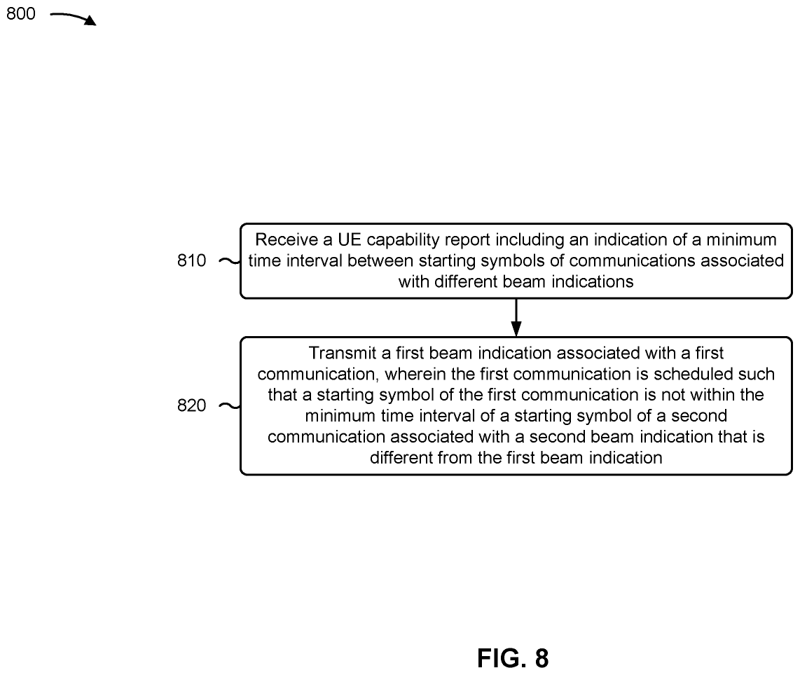

Controller/processor 240 of base station 110, controller/processor 280 of UE 120, and/or any other component(s) of FIG. 2 may perform one or more techniques associated with a beam switching gap based on UE capability, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, the UE 120 includes means for transmitting, to a base station, a UE capability report including an indication of a minimum time interval between starting symbols of communications associated with different beam indications; and/or means for receiving, from the base station, a first beam indication associated with a first communication, wherein the first communication is scheduled such that a starting symbol of the first communication is not within the minimum time interval of a starting symbol of a second communication associated with a second beam indication that is different from the first beam indication. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the base station 110 includes means for receiving, from a UE, a UE capability report including an indication of a minimum time interval between starting symbols of communications associated with different beam indications; and/or means for transmitting, to the UE, a first beam indication associated with a first communication, wherein the first communication is scheduled such that a starting symbol of the first communication is not within the minimum time interval of a starting symbol of a second communication associated with a second beam indication that is different from the first beam indication. The means for the base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

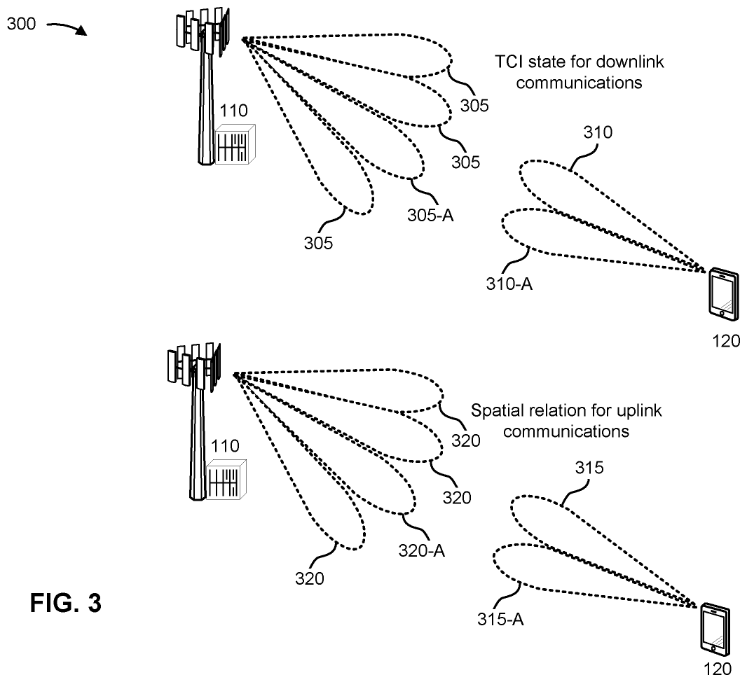

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may identify a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a transmission configuration indication (TCI) state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 315-A and the BS receive beam 320-A), which may be further refined and maintained in accordance with one or more established beam refinement procedures. An uplink beam, such as a UE transmit beam 315 or a BS receive beam 320, may be associated with a spatial relation. A spatial relation may indicate a directionality or a characteristic of the uplink beam, similar to one or more QCL properties, as described above.

In some examples, the base station 110 may transmit, to the UE 120, a beam indication that indicates a BS transmit beam for a downlink communication, and the beam indication may cause the UE 120 to switch from another UE receive beam to a UE receive beam that corresponds to the indicated BS transmit beam for the downlink communication. In some examples, the base station 110, may transmit, to the UE 120, a beam indication that indicates a UE transmit beam for an uplink communication, and the beam indication may cause the UE 120 to switch from another UE transmit beam to the indicated UE transmit beam for the uplink communication. An indication that causes the UE 120 to switch UE receive beams or UE transmit beams for a downlink or uplink communication may be referred herein as a “beam switching command.”

As indicated above, FIG. 3 is provided as an example. Other examples may differ from what is described with respect to FIG. 3.

For NR communications using high carrier frequencies (e.g., FR4) OFDM waveforms with large subcarrier spacing (SCS) (e.g., 240 kHz-1.92 MHz) may be used to combat server phase noise. In such cases, due to the large SCS, the slot length may be very short. For example, in FR2 with 120 kHz SCS, the slot length may be 125 μS, while in FR4 with 960 kHz SCS, the slot length may be 15.6 μs. However, frequent beam switching and/or downlink/uplink switching may result in increased overhead at higher SCS, and radio frequency hardware components of a UE may not have the capability to process beam switching commands in a timeline that scales with the shortened slot length. In some cases, a UE may not be able to process a beam switch command if the arrival time is very close to a previous beam switch command, for example, due to a limited processing capability at the UE. For example, a UE may not be able to perform beam switching immediately after receiving a beam indication, and the UE may only be able to perform the beam switching within a small time period before receiving or transmitting on a new beam. This may result in the ULE being unable to switch beams in time to transmit or receive a scheduled communication, on the beam indicated by a base station for that communication, which may cause reduced network reliability, increased network latency, and increased UE power consumption due to having to repeat uplink transmissions and/or monitoring for downlink receptions.

Some techniques and apparatuses described herein enable a UE to transmit, to a base station, a UE capability report including an indication of a minimum time interval between starting symbols of communications associated with different beam indications (e.g., different beam switching commands). The UE may receive, from the base station, a beam indication associated with a first communication (e.g., downlink or uplink communication), and the communication may be scheduled, by the base station, such that a starting symbol of the communication is not within the minimum time interval of a starting symbol of another communication associated with a different beam indication. As a result, communications associated with different beam indications (e.g., different beam switching commands) may be scheduled for a UE, based at least in part on a capability of the UE, such that UE has sufficient time to process the beam switching commands before applying the beam switching and communicating using the indicated beams. This may result in increased network reliability, decreased network latency, and reduced power consumption (e.g., due to fewer repeated uplink transmissions and monitoring for downlink receptions).

In some aspects, the UE capability report may also include an indication of a maximum number of communications, associated with different beam indications, to have starting symbols in a certain time duration. In some aspects, a communication associated with a beam indication (e.g., beam switching command) may be scheduled such that a total number of communications, associated with different beam indications, does not exceed the maximum number within the time duration. As a result, based at least in part on a capability of a UE, communications are not scheduled, for the UE, on more different beams than the UE can support in a certain time duration. This may result in increased network reliability, decreased network latency, and reduced power consumption (e.g., due to fewer repeated uplink transmissions and monitoring for downlink receptions).

FIG. 4 is a diagram illustrating an example 400 associated with a beam switching gap based on UE capability, in accordance with the present disclosure. As shown in FIG. 4, example 400 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the base station 110 and the UE 120 may communicate using high carrier frequencies, such as carrier frequencies in FR4.

As shown in FIG. 4, and by reference number 405, the UE 120 may transmit, to the base station 110, a UE capability report. The UE 120 capability report may include an indication of a minimum time interval between starting symbols of communications (e.g., downlink and/or uplink communications) associated with different beam indications. The minimum time interval may be based at least in part on a capability of the UE 120 to process different beam switching commands. For example, the minimum time interval may be equal to or based at least in part on a minimum processing time, after the UE 120 applies a first beam indication/beam switch command, for the UE 120 to process and apply a second beam indication/beam switch command. In some aspects, the minimum time interval may be a minimum number of symbols or slots between different beam indications/beam switching commands. A “beam indication” for a communication may be an explicit beam indication for a beam to be used to transmit or receive the communication, such as an indication of a TCI state, QCL properties, and/or spatial relation information for a beam or an indication associated with a communication on a default beam (e.g., a default beam associated with a CORESET).

In some aspects, the UE capability report may include an indication of a maximum number of different beam indications (e.g., beam switching commands) to be applied for communications having starting symbols within a time duration. That is, the UE 120 may indicate, in the UE capability report, the maximum number of communications (e.g., downlink and/or uplink communications), associated with different beam indications, that have starting symbols in the time duration. The maximum number may be equal to or based at least in part on a maximum number of different beams that the UE 120 can support within the time duration. The time duration may be preset (e.g., in a wireless communication standard), configured for the UE 120 (e.g., by the base station 110), indicated, by the UE 120, in the UE capability report, or a combination thereof.

As further shown in FIG. 4, and by reference number 410, the base station 110 may transmit, and the UE 120 may receive, a first beam indication associated with a first communication (e.g., downlink or uplink communication) for the UE 120. The first communication may be a communication to be received or transmitted using a first beam corresponding to the first beam indication. In some aspects, the first beam indication may be transmitted with scheduling information (e.g., resource allocation information) that schedules the first communication.

In some aspects, the first beam indication may indicate a beam for the UE 120 to use for reception of a periodic or semi-persistent downlink communication or transmission of a periodic or semi-persistent uplink communication. For example, the first beam indication may indicate a beam for the UE 120 to use for receiving PDCCH communications transmitted from the base station 110, a beam for the UE 120 to use for receiving periodic CSI-RSs transmitted from the base station 110, or a beam for the UE 120 to use for transmitting periodic sounding reference signals (SRSs) to the base station 110. In some aspects, the first indication may include an indication of a TCI state, QCL properties, and/or spatial relation information, for a beam to be used for the periodic or semi-persistent communication. In some aspects, the base station 110 may transmit, and the UE 120 may receive, the first beam indication in an RRC message or a medium access control (MAC) control element (MAC-CE) that schedules the periodic or semi-persistent communication.

In some aspects, the first beam indication may indicate a beam for the UE 120 to use for a dynamically granted downlink (e.g., PDSCH) or uplink (e.g., physical uplink shared channel (PUSCH)) communication. In some aspects, the first communication may be a dynamically granted downlink communication or a dynamically granted uplink communications, and the first beam indication may be included in downlink control information (DCI) that schedules the first communication. For example, the base station 110 may transmit, and the UE 120 may receive, a PDCCH communication including DCI that includes scheduling information for the first communication and the first beam indication. In some aspects, the first beam indication may include an indication of a TCI state, QCL properties, and/or spatial relation information, for the beam to be used for the dynamically granted downlink or uplink communication. In some aspects, such as in a case in which the first communication is a downlink (e.g., PDSCH) communication, the first beam indication may be included in a TCI field in the DCI that schedules the first communication. In some aspects, such as in a case in which the first communication is an uplink (e.g., PUSCH) communication, the first beam indication may be included in an SRS indicator (SRI) field of the DCI that schedules the first communication.

In some aspects, the first beam indication may correspond to a default beam for a communication, such as a default beam associated with a CORESET configured for the UE 120. For example, the first beam indication may correspond to a default beam associated with a CORESET of a lowest ID for a PDSCH communication transmitted within a certain amount of time (e.g., timeDurationForQCL) of receiving DCI in a PDCCH communication on a beam associated with the CORESET of the lowest ID. In this case, the first beam indication may not be provided using an explicit beam indication. For example, the first beam indication may be provided by scheduling the first communication (e.g., PDSCH communication) within the certain amount of time of the PDCCH communication on the beam associated with the CORESET of the lowest ID.

As further shown in FIG. 4, and by reference number 415, the base station 110 may transmit, and the UE 120 may receive, a second beam indication associated with a second communication (e.g., downlink or uplink communication) for the UE 120. The second communication may be a communication to be received or transmitted using a second beam corresponding to the second beam indication. In some aspects, the second beam indication may be transmitted with scheduling information (e.g., resource allocation information) that schedules the second communication.

In some aspects, the second beam indication may indicate a beam for the UE 120 to use for reception of a periodic or semi-persistent downlink communication or transmission of a periodic or semi-persistent uplink communication. For example, the second beam indication may indicate a beam for the UE 120 to use for receiving PDCCH communications transmitted from the base station 110, a beam for the UE 120 to use for receiving periodic CSI-RSs transmitted from the base station 110, or a beam for the UE 120 to use for transmitting periodic SRSs to the base station 110. In some aspects, the second indication may include an indication of a TCI state, QCL properties, and/or spatial relation information, for a beam to be used for the periodic or semi-persistent communication. In some aspects, the base station 110 may transmit, and the UE 120 may receive, the second beam indication in an RRC message or a MAC-CE that schedules the periodic or semi-persistent communication.

In some aspects, the second beam indication may indicate a beam for the UE 120 to use for a dynamically granted downlink (e.g., PDSCH) or uplink (e.g., PUSCH) communication. In some aspects, the base station 110 may transmit, and the UE 120 may receive, the second beam indication in DCI (e.g., in transmitted via a PDCCH communication) that schedules the dynamically granted downlink or uplink communication. In some aspects, the second beam indication may include an indication of a TCI state, QCL properties, and/or spatial relation information, for the beam to be used for the dynamically granted downlink or uplink communication. In some aspects, such as in a case in which the second communication is a downlink (e.g., PDSCH) communication, the second beam indication may be included in a TCI field in the DCI that schedules the second communication. In some aspects, such as in a case in which the second communication is an uplink (e.g., PUSCH) communication, the second beam indication may be included in an SRI field of the DCI that schedules the first communication.

In some aspects, the second beam indication may correspond to a default beam for a communication, such as a default beam associated with a CORESET configured for the UE 120. For example, the second beam indication may correspond to a default beam associated with a CORESET of a lowest ID for a PDSCH communication transmitted within a certain amount of time (e.g., timeDurationForQCL) of receiving DCI in a PDCCH communication on a beam associated with the CORESET of the lowest ID. In this case, the second beam indication may not be provided using an explicit beam indication. For example, the second beam indication may be provided by scheduling the second communication (e.g., PDSCH communication) within the certain amount of time of the PDCCH communication on the beam associated with the CORESET of the lowest ID.

In some aspects, the second beam indication may be different (e.g., indicating a different beam) from the first beam indication. For example, the first beam indication may be a first beam switching command for the UE 120 to switch to the first beam for the first communication, and the second beam indication may be a first beam switching command for the UE 120 to switch to the second beam for the second communication. In some aspects, the second communication associated with the second beam indication, may be scheduled such that a starting symbol of the second communication is not within the minimum time interval, indicated in the UE capability report, of a starting symbol of the first communication associated with the first beam indication. For example, based at least in part on the minimum time interval indicated in the UE capability report, the base station 110 may schedule the first and second communications (on different beams), such that the starting symbols of the first and second communications are not within the minimum time interval of each other.

In some aspects, a beam associated with a beam indication may last for a number of symbols (Y) after the UE 120 applies a beam switching command to switch to that beam. In this case, a communication (e.g., the first or second communication) associated with a beam indication (e.g., the first or second beam indication) may last up to Y symbols. In some aspects, the minimum time interval (X), indicated in the UE capability report, may be less than Y. In this case, the second communication may be scheduled to begin on the second beam before prior to an end (e.g., a last symbol) of the first communication scheduled on the first beam, as long as the starting symbol of the of the second communication is at least X symbols after the starting symbol of the first communication. In some aspects, X may be greater than or equal to Y. In this case, the second communication may be scheduled to begin on the second beam after the first communication is scheduled to end on the first beam.

In some aspects, first and second communications may be scheduled such that a total number of different beam indications (e.g., beam switching commands) to be applied for communications having starting symbols within a time duration does not exceed the maximum number, indicated in the UE capability report, for the time duration. For example, based at least in part on the maximum number indicated in the UE capability report, the base station 110 may schedule the first and second communications such that the total number of communications, associated with different beam indications, that have starting symbols in the time duration does not exceed the maximum number. The total number of communications, associated with different beam indications, may include the first communication (associated with the first beam indication), the second communication (associated with the second beam indication), and/or any other communication associated with another beam indication. For example, the total number of communications, associated with different beam indications, with starting symbols in the time duration may include a count of periodic or semi-persistent communications associated with beam indications received via RRC messages or MAC-CEs, dynamically scheduled communications associated with beam indications received via DCI, and communications on a default beam configured for the UE, that are associated with different beam indications and have starting symbols in the time duration.

As further shown in FIG. 4, and by reference number 420, the UE 120 may receive or transmit the first communication on the first beam. In some aspects, the first communication may be a downlink communication. In this case, the base station 110 may transmit the first communication to the UE 120, and the UE 120 may receive the first communication on the first beam associated with the first beam indication. In some aspects, the first communication may be an uplink communication. In this case, the UE 120 may transmit the first communication to the base station 110 on the first beam associated with the first beam indication, and the base station 110 may receive the first communication.

As further shown in FIG. 4, and by reference number 425, the UE 120 may receive or transmit the second communication on the second beam. In some aspects, the second communication may be a downlink communication. In this case, the base station 110 may transmit the second communication to the UE 120, and the UE 120 may receive the second communication on the second beam associated with the second beam indication. In some aspects, the first communication may be an uplink communication. In this case, the UE 120 may transmit the second communication to the base station 110 on the second beam associated with the first beam indication, and the base station 110 may receive the second communication.

In some aspects, the reception and/or transmission of first communication and the second communication by the UE 120 may be scheduled such that a time interval between the starting symbols of the first communication and the second communication that is greater than or equal to the minimum time interval indicated in the UE capability report. In some aspects, the reception and/or transmission of the first communication and the second communication by the UE 120 may be scheduled such that the total number of communications, associated with different beam indications, with starting symbols within a time duration does not exceed the maximum number indicated in the UE capability report.

As described above in connection with FIG. 4, the UE 120 may transmit, to the base station 110, a UE capability report including an indication of a minimum time interval between starting symbols of communications associated with different beam indications (e.g., different beam switching commands). The UE 120 may receive, from the base station, a first beam indication associated with a first communication and a second beam indication associated with a second communication. The first and second communications may be scheduled (e.g., by the base station 110) such that the starting symbols of the first and second communications are not within the minimum time interval indicated in the UE capability report. As a result, communications associated with different beam indications (e.g., different beam switching commands) may be scheduled for the UE 120, based at least in part on a capability of the UE 120, such that UE 120 has sufficient time to process the beam switching commands before applying the beam switching and beginning a communication using the indicated beams. This may result in increased network reliability, decreased network latency, and reduced power consumption (e.g., due to fewer repeated uplink transmissions and monitoring for downlink receptions).

In some aspects, as described above in connection with FIG. 4, the UE capability report may also include an indication of a maximum number of communications, associated with different beam indications, to have starting symbols in a certain time duration. The first communication associated with the first beam indication, and the second communication associated with the second beam indication, may be scheduled (e.g., by the base station 110) such that a total number of communications, associated with different beam indications, within the time duration does not exceed the maximum number indicated in the UE capability report. As a result, based at least in part on a capability of a UE 120, communications may not be scheduled for the UE 120 on more different beams than the UE 120 can support in a certain time duration. This may result in increased network reliability, decreased network latency, and reduced power consumption (e.g., due to fewer repeated uplink transmissions and monitoring for downlink receptions).

As indicated above, FIG. 4 is provided as an example. Other examples may differ from what is described with respect to FIG. 4.

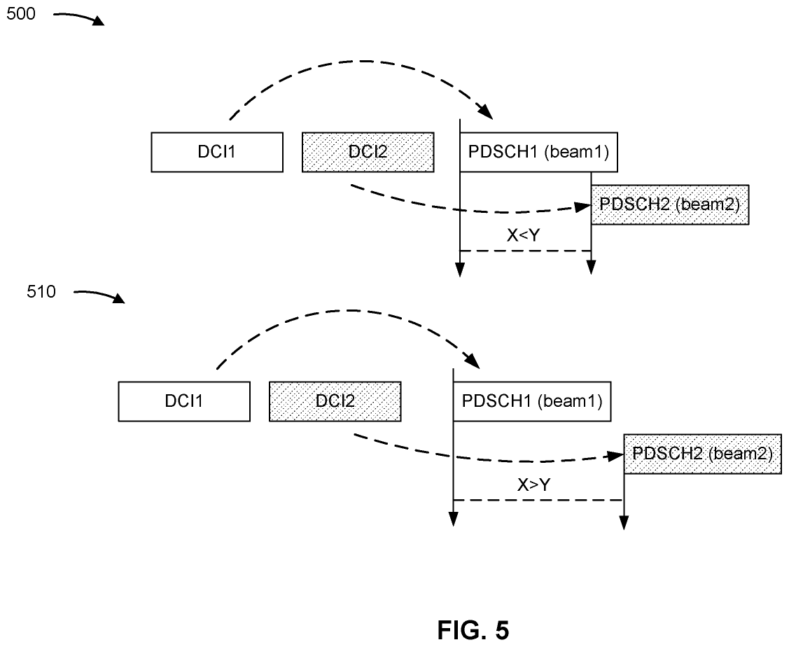

FIG. 5 is a diagram illustrating examples 500 and 510 associated with a beam switching gap based on UE capability, in accordance with the present disclosure. As shown in example 500 of FIG. 5, a UE (e.g., UE 120) may receive, from a base station (e.g., base station 110), first DCI (DCI1) that schedules a first PDSCH communication (PDSCH1) and second DCI (DCI2) that schedules a second PDSCH communication (PDSCH2). DCI1 may include a first beam indication that indicates a first beam (beam1) for PDSCH1. DCI2 may include a second beam indication that indicates a second beam (beam2) for PDSCH2. In some aspects, the UE may receive DCI1 and DCI2 on a same beam, such as beam1 or another beam associated with receiving PDCCH communications. In some aspects, PDSCH2 may be scheduled (e.g., by the base station) such that a starting symbol of PDSCH2 is not within a minimum time interval (X) of a starting symbol of PDSCH1. In some aspects, X may be less than a length (Y) of PDSCH1. As shown in example 500, in a case in which X<Y, the UE may be scheduled to begin receiving PDSCH2 on beam2 prior to finishing receiving PDSCH1 on beam1. This may provide a benefit of increasing network speed and reducing traffic latency for the UE, while maintaining at least the minimum time interval (X) between starting symbols of communications associated with different beam indications.

As shown in example 510 of FIG. 5, a UE (e.g., UE 120) may receive, from a base station (e.g., base station 110), DCI1 that schedules PDSCH1 and DCI2 that schedules PDSCH2. DCI1 may include a first beam indication that indicates beam1 for PDSCH1. DCI2 may include a second beam indication that indicates beam2 for PDSCH2. In some aspects, PDSCH2 may be scheduled (e.g., by the base station) such that a starting symbol of PDSCH2 is not within a minimum time interval (X) of a starting symbol of PDSCH1. In some aspects, X may be greater than a length (Y) of PDSCH1. As shown in example 510, in a case in which X>Y, the UE may be scheduled to begin receiving PDSCH2 on beam2 after receiving PDSCH1 on beam1.

As indicated above, FIG. 5 is provided as an example. Other examples may differ from what is described with respect to FIG. 5.

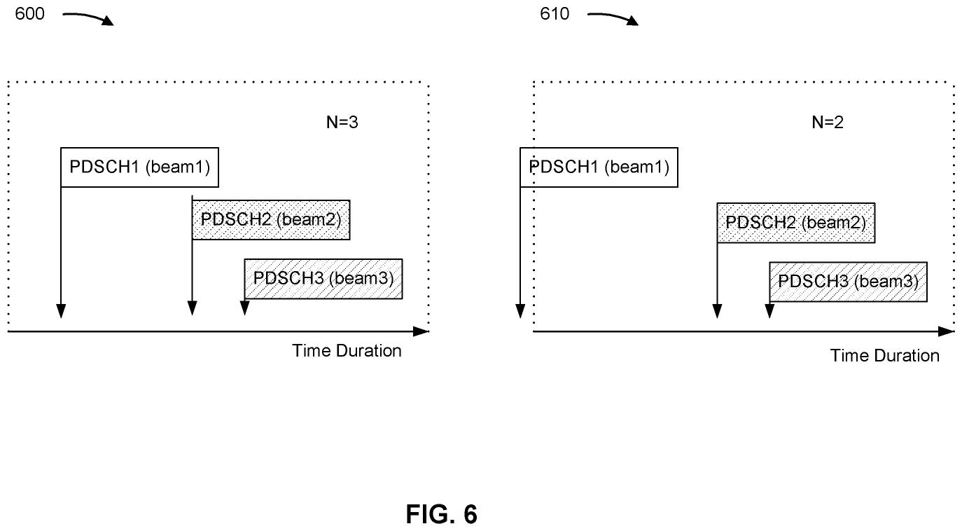

FIG. 6 is a diagram illustrating examples 600 and 610 associated with a beam switching gap based on UE capability, in accordance with the present disclosure. As described above in connection with FIG. 4, in some aspects, communications associated with different beam indications (e.g., different beam switching commands) may be scheduled (e.g., by a base station) such that a total number (N) of communications, associated with different beam indications, with starting symbols in a time duration does not exceed a maximum number indicated in a UE capability report. In some aspects, communications are counted as in the time duration or not in the time duration based on the starting symbols of the communications. As shown in examples 600 and 610, a first PDSCH communication (PDSCH1) may be scheduled for a UE on a first beam (beam1), a second PDSCH communication (PDSCH2) may be scheduled for the UE on a second beam (beam2), and a third PDSCH communication (PDSCH3) may be scheduled for the UE on a third beam (beam3). In example 600, the starting symbol for PDSCH1, the starting symbol for PDSCH2, and the starting symbol for PDSCH3 are within the time duration, and N=3. In example 610, the starting symbol of PDSCH2 and the starting symbol of PDSCH3 are within the time duration, but the starting symbol for PDSCH1 is not within the time duration. In this case, N=2, even though symbols of PDSCH1, other than the starting symbol, may be within the time duration.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with a beam switching gap based on UE capability.

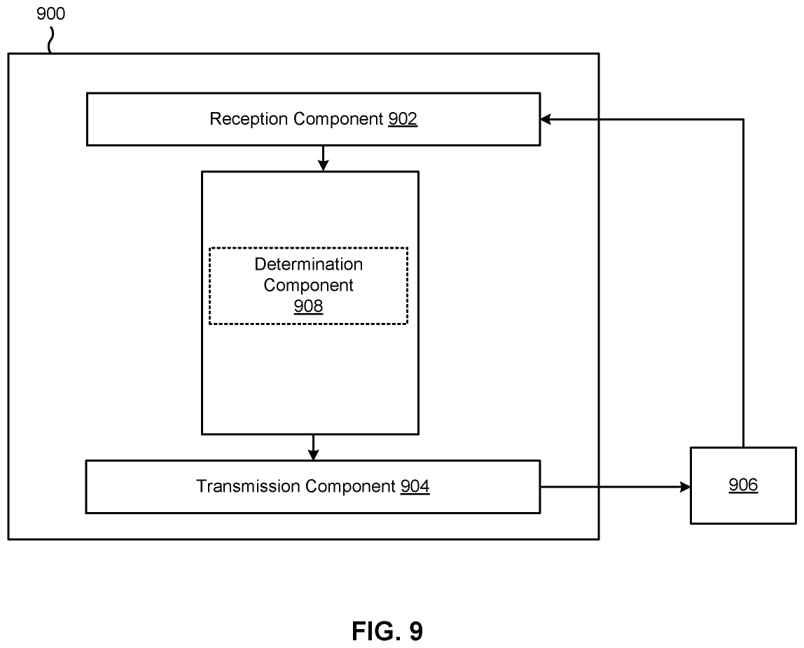

As shown in FIG. 7, in some aspects, process 700 may include transmitting, to a base station, a UE capability report including an indication of a minimum time interval between starting symbols of communications associated with different beam indications (block 710). For example, the UE (e.g., using transmission component 904, depicted in FIG. 9) may transmit, to a base station, a UE capability report including an indication of a minimum time interval between starting symbols of communications associated with different beam indications, as described above.

As further shown in FIG. 7, in some aspects, process 700 may include receiving, from the base station, a first beam indication associated with a first communication, wherein the first communication is scheduled such that a starting symbol of the first communication is not within the minimum time interval of a starting symbol of a second communication associated with a second beam indication that is different from the first beam indication (block 720). For example, the UE (e.g., using reception component 902, depicted in FIG. 9) may receive, from the base station, a first beam indication associated with a first communication, wherein the first communication is scheduled such that a starting symbol of the first communication is not within the minimum time interval of a starting symbol of a second communication associated with a second beam indication that is different from the first beam indication, as described above.

Process 700 may include additional aspects, such as any single aspect or any combination of aspects described below and/or in connection with one or more other processes described elsewhere herein.

In a first aspect, the first communication is at least one of a periodic downlink communication, a semi-persistent downlink communication, a periodic uplink communication, or a semi-persistent uplink communication, and receiving the first beam indication includes receiving the first beam indication in an RRC message that schedules the first communication or in a MAC-CE that schedules the first communication.

In a second aspect, alone or in combination with the first aspect, receiving the first beam indication includes receiving the first beam indication in DCI that schedules the first communication.

In a third aspect, alone or in combination with one or more of the first and second aspects, the first communication is a downlink communication, and the first beam indication is included in a TCI field in the DCI.

In a fourth aspect, alone or in combination with one or more of the first through third aspects, the first communication is an uplink communication, and the first beam indication is included in an SRI field in the DCI.

In a fifth aspect, alone or in combination with one or more of the first through fourth aspects, the first communication is a downlink communication, and the first beam indication corresponds to a default beam associated with a CORESET configured for the UE.

In a sixth aspect, alone or in combination with one or more of the first through fifth aspects, the second communication is one of a periodic or semi-persistent communication scheduled via an RRC message or a MAC-CE, wherein the second beam indication is included in the RRC message or the MAC-CE, a dynamically granted communication scheduled via DCI that includes the second beam indication, or a downlink communication on a default beam associated with a CORESET configured for the UE.

In a seventh aspect, alone or in combination with one or more of the first through sixth aspects, the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.

In an eighth aspect, alone or in combination with one or more of the first through seventh aspects, the total number of communications, associated with different beam indications, with starting symbols in the time duration includes a count of periodic or semi-persistent communications associated with beam indications received via RRC messages or MAC-CEs, dynamically scheduled communications associated with beam indications received via DCI, and communications on a default beam configured for the UE, that are associated with different beam indications and have starting symbols in the time duration.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with a beam switching gap based on UE capability.

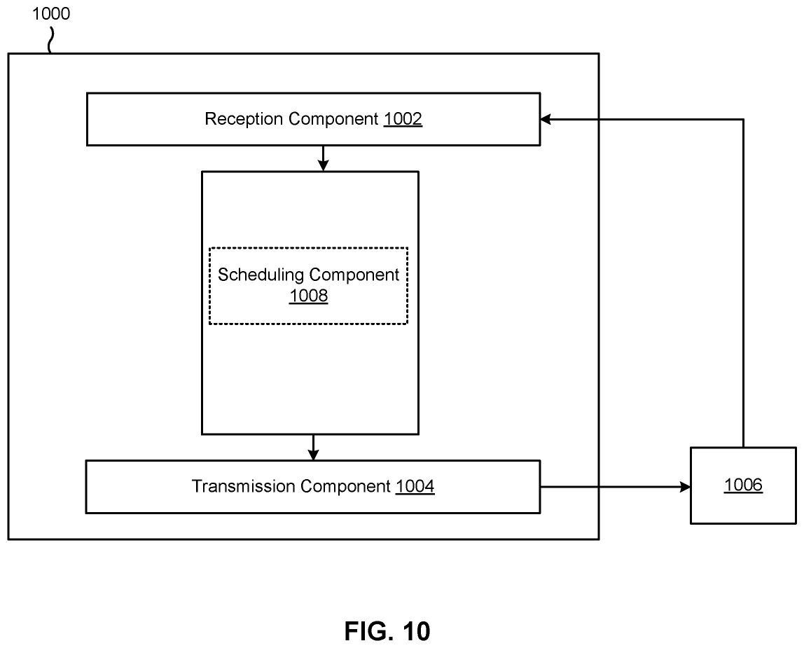

As shown in FIG. 8, in some aspects, process 800 may include receiving, from a UE, a UE capability report including an indication of a minimum time interval between starting symbols of communications associated with different beam indications (block 810). For example, the base station (e.g., using reception component 1002, depicted in FIG. 10) may receive, from a UE, a UE capability report including an indication of a minimum time interval between starting symbols of communications associated with different beam indications, as described above.

As further shown in FIG. 8, in some aspects, process 800 may include transmitting, to the UE, a first beam indication associated with a first communication, wherein the first communication is scheduled such that a starting symbol of the first communication is not within the minimum time interval of a starting symbol of a second communication associated with a second beam indication that is different from the first beam indication (block 820). For example, the base station (e.g., using transmission component 1004, depicted in FIG. 10) may transmit, to the UE, a first beam indication associated with a first communication, wherein the first communication is scheduled such that a starting symbol of the first communication is not within the minimum time interval of a starting symbol of a second communication associated with a second beam indication that is different from the first beam indication, as described above.

Process 800 may include additional aspects, such as any single aspect or any combination of aspects described below and/or in connection with one or more other processes described elsewhere herein.

In a first aspect, the first communication is at least one of a periodic downlink communication, a semi-persistent downlink communication, a periodic uplink communication, or a semi-persistent uplink communication, and transmitting the first beam indication includes transmitting the first beam indication in an RRC message that schedules the first communication or in a MAC-CE that schedules the first communication.

In a second aspect, alone or in combination with the first aspect, transmitting the first beam indication includes transmitting the first beam indication in DCI that schedules the first communication.

In a third aspect, alone or in combination with one or more of the first and second aspects, the first communication is a downlink communication, and the first beam indication is included in a TCI field in the DCI.

In a fourth aspect, alone or in combination with one or more of the first through third aspects, the first communication is an uplink communication, and the first beam indication is included in an SRS field in the DCI.

In a fifth aspect, alone or in combination with one or more of the first through fourth aspects, the first communication is a downlink communication, and the first beam indication corresponds to a default beam associated with a CORESET configured for the UE.

In a sixth aspect, alone or in combination with one or more of the first through fifth aspects, the second communication is one of a periodic or semi-persistent communication scheduled via an RRC message or a MAC-CE, wherein the second beam indication is included in the RRC message or the MAC-CE, a dynamically granted communication scheduled via DCI that includes the second beam indication, or a downlink communication on a default beam associated with a CORESET configured for the UE.

In a seventh aspect, alone or in combination with one or more of the first through sixth aspects, the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.

In an eighth aspect, alone or in combination with one or more of the first through seventh aspects, the total number of communications, associated with different beam indications, with starting symbols in the time duration includes a count of periodic or semi-persistent communications associated with beam indications received via RRC messages or MAC-CEs, dynamically scheduled communications associated with beam indications received via downlink control information, and communications on a default beam configured for the UE, that are associated with different beam indications and have starting symbols in the time duration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a determination component 908, among other examples.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be co-located with the reception component 902 in a transceiver.

The transmission component 904 may transmit, to a base station, a UE capability report including an indication of a minimum time interval between starting symbols of communications associated with different beam indications. The reception component 902 may receive, from the base station, a first beam indication associated with a first communication, wherein the first communication is scheduled such that a starting symbol of the first communication is not within the minimum time interval of a starting symbol of a second communication associated with a second beam indication that is different from the first beam indication. In some aspects, the determination component 908 may determine the minimum time interval between starting symbols of communications associated with different beam indications, and/or a maximum number of communications, associated with different beam indications, with starting symbols in a time duration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a scheduling component 1008, among other examples.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the base station described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the base station described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the base station described above in connection with FIG. 2. In some aspects, the transmission component 1004 may be co-located with the reception component 1002 in a transceiver.

The reception component 1002 may receive, from a UE, a UE capability report including an indication of a minimum time interval between starting symbols of communications associated with different beam indications. The transmission component 1004 may transmit, to the UE, a first beam indication associated with a first communication, wherein the first communication is scheduled such that a starting symbol of the first communication is not within the minimum time interval of a starting symbol of a second communication associated with a second beam indication that is different from the first beam indication. In some aspects, the scheduling component 1008 may schedule the first communication and/or the second communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting, to a base station, a UE capability report including an indication of a minimum time interval between starting symbols of communications associated with different beam indications; and receiving, from the base station, a first beam indication associated with a first communication, wherein the first communication is scheduled such that a starting symbol of the first communication is not within the minimum time interval of a starting symbol of a second communication associated with a second beam indication that is different from the first beam indication.

Aspect 2: The method of Aspect 1, wherein the first communication is at least one of a periodic downlink communication, a semi-persistent downlink communication, a periodic uplink communication, or a semi-persistent uplink communication, and receiving the first beam indication comprises: receiving the first beam indication in a radio resource control message that schedules the first communication or in a medium access control (MAC) control element (MAC-CE) that schedules the first communication.

Aspect 3: The method of Aspect 1, wherein receiving the first beam indication comprises: receiving the first beam indication in downlink control information that schedules the first communication.

Aspect 4: The method of Aspect 3, wherein the first communication is a downlink communication, and the first beam indication is included in a transmission configuration indicator field in the downlink control information.

Aspect 5: The method of Aspect 3, wherein the first communication is an uplink communication, and the first beam indication is included in a sounding reference signal resource indicator field in the downlink control information.

Aspect 6: The method of Aspect 1, wherein the first communication is a downlink communication, and the first beam indication corresponds to a default beam associated with a control resource set configured for the UE.

Aspect 7: The method of any of Aspects 1-6, wherein the second communication is one of: a periodic or semi-persistent communication scheduled via a radio resource control (RRC) message or a medium access control (MAC) control element (MAC-CE), wherein the second beam indication is included in the RRC message or the MAC-CE; a dynamically granted communication scheduled via downlink control information that includes the second beam indication; or a downlink communication on a default beam associated with a control resource set configured for the UE.

Aspect 8: The method of any of Aspects 1-7, wherein the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.

Aspect 9: The method of Aspect 8, wherein the total number of communications, associated with different beam indications, with starting symbols in the time duration includes a count of periodic or semi-persistent communications associated with beam indications received via radio resource control messages or medium access control (MAC) control elements, dynamically scheduled communications associated with beam indications received via downlink control information, and communications on a default beam configured for the UE, that are associated with different beam indications and have starting symbols in the time duration.

Aspect 10: A method of wireless communication performed by a base station, comprising: receiving, from a user equipment (UE), a UE capability report including an indication of a minimum time interval between starting symbols of communications associated with different beam indications; and transmitting, to the UE, a first beam indication associated with a first communication, wherein the first communication is scheduled such that a starting symbol of the first communication is not within the minimum time interval of a starting symbol of a second communication associated with a second beam indication that is different from the first beam indication.

Aspect 11: The method of Aspect 10, wherein the first communication is at least one of a periodic downlink communication, a semi-persistent downlink communication, a periodic uplink communication, or a semi-persistent uplink communication, and transmitting the first beam indication comprises: transmitting the first beam indication in a radio resource control message that schedules the first communication or in a medium access control (MAC) control element (MAC-CE) that schedules the first communication.

Aspect 12: The method of Aspect 10, wherein transmitting the first beam indication comprises: transmitting the first beam indication in downlink control information that schedules the first communication.

Aspect 13: The method of Aspect 12, wherein the first communication is a downlink communication, and the first beam indication is included in a transmission configuration indicator field in the downlink control information.

Aspect 14: The method of Aspect 12, wherein the first communication is an uplink communication, and the first beam indication is included in a sounding reference signal resource indicator field in the downlink control information.

Aspect 15: The method of Aspect 10, wherein the first communication is a downlink communication, and the first beam indication corresponds to a default beam associated with a control resource set configured for the UE.

Aspect 16: The method of any of Aspects 10-15, wherein the second communication is one of: a periodic or semi-persistent communication scheduled via a radio resource control (RRC) message or a medium access control (MAC) control element (MAC-CE), wherein the second beam indication is included in the RRC message or the MAC-CE; a dynamically granted communication scheduled via downlink control information that includes the second beam indication; or a downlink communication on a default beam associated with a control resource set configured for the UE.

Aspect 17: The method of any of Aspects 10-16, wherein the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.

Aspect 18: The method of Aspect 17, wherein the total number of communications, associated with different beam indications, with starting symbols in the time duration includes a count of periodic or semi-persistent communications associated with beam indications received via radio resource control messages or medium access control (MAC) control elements, dynamically scheduled communications associated with beam indications received via downlink control information, and communications on a default beam configured for the UE, that are associated with different beam indications and have starting symbols in the time duration.

Aspect 19: An apparatus for wireless communication at a device, comprising a processor; memory coupled with the processor; and instructions stored in the memory and executable by the processor to cause the apparatus to perform the method of one or more of Aspects 1-9.

Aspect 20: An apparatus for wireless communication at a device, comprising a processor; memory coupled with the processor; and instructions stored in the memory and executable by the processor to cause the apparatus to perform the method of one or more of Aspects 10-18.

Aspect 21: A device for wireless communication, comprising a memory and one or more processors coupled to the memory, the memory and the one or more processors configured to perform the method of one or more of Aspects 1-9.

Aspect 22: A device for wireless communication, comprising a memory and one or more processors coupled to the memory, the memory and the one or more processors configured to perform the method of one or more of Aspects 10-18.

Aspect 23: An apparatus for wireless communication, comprising at least one means for performing the method of one or more of Aspects 1-9.

Aspect 24: An apparatus for wireless communication, comprising at least one means for performing the method of one or more of Aspects 10-18.

Aspect 25: A non-transitory computer-readable medium storing code for wireless communication, the code comprising instructions executable by a processor to perform the method of one or more of Aspects 1-9.

Aspect 26: A non-transitory computer-readable medium storing code for wireless communication, the code comprising instructions executable by a processor to perform the method of one or more of Aspects 10-18.

Aspect 27: A non-transitory computer-readable medium storing a set of instructions for wireless communication, the set of instructions comprising one or more instructions that, when executed by one or more processors of a device, cause the device to perform the method of one or more of Aspects 1-9.

Aspect 28: A non-transitory computer-readable medium storing a set of instructions for wireless communication, the set of instructions comprising one or more instructions that, when executed by one or more processors of a device, cause the device to perform the method of one or more of Aspects 10-18.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a base station, a UE capability report including an indication of a minimum time interval between starting symbols of communications associated with different beam indications; and
receive, from the base station, a first beam indication associated with a first communication, wherein the first communication is scheduled such that a starting symbol of the first communication is not within the minimum time interval of a starting symbol of a second communication associated with a second beam indication that is different from the first beam indication.

2. The UE of claim 1, wherein the one more processors, to receive the first beam indication, are configured to:
receive the first beam indication in a radio resource control message that schedules the first communication or in a medium access control (MAC) control element (MAC-CE) that schedules the first communication, wherein the first communication is at least one of a periodic downlink communication, a semi-persistent downlink communication, a periodic uplink communication, or a semi-persistent uplink communication.

3. The UE of claim 1, wherein the one more processors, to receive the first beam indication, are configured to:
receive the first beam indication in downlink control information that schedules the first communication.

4. The UE of claim 3, wherein the first communication is a downlink communication, and the first beam indication is included in a transmission configuration indicator field in the downlink control information.

5. The UE of claim 3, wherein the first communication is an uplink communication, and the first beam indication is included in a sounding reference signal resource indicator field in the downlink control information.

6. The UE of claim 1, wherein the first communication is a downlink communication, and the first beam indication corresponds to a default beam associated with a control resource set configured for the UE.

7. The UE of claim 1, wherein the second communication is one of:
a periodic or semi-persistent communication scheduled via a radio resource control (RRC) message or a medium access control (MAC) control element (MAC-CE), wherein the second beam indication is included in the RRC message or the MAC-CE;
a dynamically granted communication scheduled via downlink control information that includes the second beam indication; or
a downlink communication on a default beam associated with a control resource set configured for the UE.

8. The UE of claim 1, wherein the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.

9. The UE of claim 8, wherein the total number of communications, associated with different beam indications, with starting symbols in the time duration includes a count of periodic or semi-persistent communications associated with beam indications received via radio resource control messages or medium access control (MAC) control elements, dynamically scheduled communications associated with beam indications received via downlink control information, and communications on a default beam configured for the UE, that are associated with different beam indications and have starting symbols in the time duration.

10. A base station for wireless communication, comprising:
a memory; and
one or more processors, coupled to the memory, configured to:
receive, from a user equipment (UE), a UE capability report including an indication of a minimum time interval between starting symbols of communications associated with different beam indications; and
transmit, to the UE, a first beam indication associated with a first communication, wherein the first communication is scheduled such that a starting symbol of the first communication is not within the minimum time interval of a starting symbol of a second communication associated with a second beam indication that is different from the first beam indication.

11. The base station of claim 10, wherein the one or more processors, to transmit the first beam indication, are configured to:
transmit the first beam indication in a radio resource control message that schedules the first communication or in a medium access control (MAC) control element (MAC-CE) that schedules the first communication, wherein the first communication is at least one of a periodic downlink communication, a semi-persistent downlink communication, a periodic uplink communication, or a semi-persistent uplink communication.

12. The base station of claim 10, wherein the one or more processors, to transmit the first beam indication, are configured to:
transmit the first beam indication in downlink control information that schedules the first communication.

13. The base station of claim 12, wherein the first communication is a downlink communication, and the first beam indication is included in a transmission configuration indicator field in the downlink control information.

14. The base station of claim 12, wherein the first communication is an uplink communication, and the first beam indication is included in a sounding reference signal resource indicator field in the downlink control information.

15. The base station of claim 10, wherein the first communication is a downlink communication, and the first beam indication corresponds to a default beam associated with a control resource set configured for the UE.

16. The base station of claim 10, wherein the second communication is one of:
a periodic or semi-persistent communication scheduled via a radio resource control (RRC) message or a medium access control (MAC) control element (MAC-CE), wherein the second beam indication is included in the RRC message or the MAC-CE;
a dynamically granted communication scheduled via downlink control information that includes the second beam indication; or
a downlink communication on a default beam associated with a control resource set configured for the UE.

17. The base station of claim 10, wherein the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.

18. The base station of claim 17, wherein the total number of communications, associated with different beam indications, with starting symbols in the time duration includes a count of periodic or semi-persistent communications associated with beam indications received via radio resource control messages or medium access control (MAC) control elements, dynamically scheduled communications associated with beam indications received via downlink control information, and communications on a default beam configured for the UE, that are associated with different beam indications and have starting symbols in the time duration.

19. A method of wireless communication performed by a user equipment (UE), comprising:
transmitting, to a base station, a UE capability report including an indication of a minimum time interval between starting symbols of communications associated with different beam indications; and
receiving, from the base station, a first beam indication associated with a first communication, wherein the first communication is scheduled such that a starting symbol of the first communication is not within the minimum time interval of a starting symbol of a second communication associated with a second beam indication that is different from the first beam indication.

20. The method of claim 19, wherein the first communication is at least one of a periodic downlink communication, a semi-persistent downlink communication, a periodic uplink communication, or a semi-persistent uplink communication, and receiving the first beam indication comprises:
receiving the first beam indication in a radio resource control message that schedules the first communication or in a medium access control (MAC) control element (MAC-CE) that schedules the first communication.

21. The method of claim 19, wherein receiving the first beam indication comprises:
receiving the first beam indication in downlink control information that schedules the first communication.

22. The method of claim 21, wherein the first communication is a downlink communication, and the first beam indication is included in a transmission configuration indicator field in the downlink control information.

23. The method of claim 21, wherein the first communication is an uplink communication, and the first beam indication is included in a sounding reference signal resource indicator field in the downlink control information.

24. The method of claim 19, wherein the first communication is a downlink communication, and the first beam indication corresponds to a default beam associated with a control resource set configured for the UE.

25. The method of claim 19, wherein the second communication is one of:
a periodic or semi-persistent communication scheduled via a radio resource control (RRC) message or a medium access control (MAC) control element (MAC-CE), wherein the second beam indication is included in the RRC message or the MAC-CE;
a dynamically granted communication scheduled via downlink control information that includes the second beam indication; or
a downlink communication on a default beam associated with a control resource set configured for the UE.

26. The method of claim 19, wherein the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.

27. The method of claim 26, wherein the total number of communications, associated with different beam indications, with starting symbols in the time duration includes a count of periodic or semi-persistent communications associated with beam indications received via radio resource control messages or medium access control (MAC) control elements, dynamically scheduled communications associated with beam indications received via downlink control information, and communications on a default beam configured for the UE, that are associated with different beam indications and have starting symbols in the time duration.

28. A method of wireless communication performed by a base station, comprising:
receiving, from a user equipment (UE), a UE capability report including an indication of a minimum time interval between starting symbols of communications associated with different beam indications; and
transmitting, to the UE, a first beam indication associated with a first communication, wherein the first communication is scheduled such that a starting symbol of the first communication is not within the minimum time interval of a starting symbol of a second communication associated with a second beam indication that is different from the first beam indication.

29. The method of claim 28, wherein the second communication is one of:
a periodic or semi-persistent communication scheduled via a radio resource control (RRC) message or a medium access control (MAC) control element (MAC-CE), wherein the second beam indication is included in the RRC message or the MAC-CE;
a dynamically granted communication scheduled via downlink control information that includes the second beam indication; or
a downlink communication on a default beam associated with a control resource set configured for the UE.

30. The method of claim 28, wherein the UE capability report includes an indication of a maximum number of communications, associated with different beam indications, with starting symbols in a time duration, and wherein the first communication is scheduled such that a total number of communications, associated with different beam indications, with starting symbols in the time duration does not exceed the maximum number.
